(19) United States
(12) Patent Application Publication
(10) Pub. No.: US 2004/0227396 A1
(43) Pub. Date: Nov. 18, 2004

(54) Hydraulic brake apparatus for a vehicle

(75) Inventor: Akihito Kusano, Toyota city (JP)

Correspondence Address: BURNS DOANE SWECKER & MATHIS L L P, POST OFFICE BOX 1404, ALEXANDRIA, VA, 22313-1404, US

(73) Assignee: ADVICS CO., LTD.

(21) Appl. No.: 10/699,678

(22) Filed: Nov. 4, 2003

(30) Foreign Application Priority Data
Nov. 5, 2002 (JP) 2002-320637

(51) Int. Cl. B60T 8/34

(52) U.S. Cl. 303/113.1; 303/114.1

(57) ABSTRACT

The present invention is directed to a hydraulic brake apparatus provided with a pressure source for generating hydraulic pressure, a pressure regulator valve for regulating the hydraulic pressure generated by the pressure source in response to an input state, a master cylinder having a master piston for defining a pressure chamber for receiving therein the hydraulic pressure fed from the pressure regulator valve, and a master chamber for discharging hydraulic braking pressure. The hydraulic braking pressure discharged from the master chamber is set to be lower than the hydraulic pressure in the pressure chamber, to produce a pressure difference increased in response to advance of the master piston. A wheel brake cylinder is operatively mounted on each wheel of the vehicle for applying braking force to each wheel. A pressure control valve is disposed between the master chamber and the wheel brake cylinder to control the hydraulic braking pressure in the wheel brake cylinder. And, a pressure supply device (including a relief valve) is provided for supplying the hydraulic pressure in the pressure chamber reduced in pressure by a predetermined value, into the master chamber.

This application claims priority under 35 U.S.C. Sec.119 to No.2002-320637 filed in Japan on Nov. 5, 2002, the entire content of which is herein incorporated by reference.

### BACKGROUND OF THE INVENTION

1. Field of the Invention

The present invention relates to a hydraulic brake apparatus for supplying hydraulic brake pressure to each wheel brake cylinder operatively mounted on each wheel of a vehicle, and more particularly to the apparatus which is provided with a pressure control valve for controlling the hydraulic pressure supplied from a master cylinder to each wheel brake cylinder.

2. Description of the Related Arts

Heretofore, there is known a hydraulic brake apparatus for a vehicle provided with a pressure control valve, which is adapted to perform an anti-skid control or the like, as disclosed in the U.S. Pat. No. 4,557,528, which corresponds to Japanese Patent Laid-open Publication No.59-130769, for example, and which discloses a hydraulic vehicle brake system with brake force amplification and anti-skid regulation by use of anti-skid regulation valves and having at least one closed brake circuit, the main brake cylinder piston of which is acted upon by a pilot pressure fed in by a brake valve.

In the U.S. patent as described above, it is stated that the anti-skid regulation valves are preceded by a valve assembly which upon the actuation of the anti-skid regulation valves disconnects the anti-skid regulation valves from the main brake cylinder and connects them to a pilot pressure. This switchover is effected in the presence of an anti-skid regulating signal and/or a predetermined deflection of the brake pedal of a main brake cylinder piston. Furthermore, it is stated in the U.S. patent that via a switch 6, an indication is given when the piston belonging to output I is highly deflected. It responds in the event of the failure of the brake circuit connected at the output I. By means of the switch 7, a signal is generated whenever the brake pedal 4 or the piston belonging to circuit II is deflected by a predetermined distance (for instance, 50%).

In general, according to the hydraulic brake apparatus capable of performing the antis-skid control or the vehicle stability control, there are provided a pressure source for generating hydraulic pressure, a master cylinder actuated by controlling the hydraulic pressure in response to an input state, e.g., braking operation by a vehicle driver, or operation of automatic pressurizing means, to advance a master piston, thereby to discharge hydraulic braking pressure from a master chamber, a wheel brake cylinder operatively mounted on each wheel of the vehicle for applying braking force thereto with the hydraulic braking pressure fed from the master chamber, and a pressure control valve disposed in a passage (master cylinder pressure circuit) between the master chamber and the wheel brake cylinder for controlling the hydraulic braking pressure in the wheel brake cylinder.

In addition to the structure as described above, such a hydraulic brake apparatus has been known that a pressure regulator valve is provided for regulating the hydraulic pressure generated by the pressure source in response to braking system by a vehicle driver, or operation of the automatic pressurizing means for use in an automatic braking system or the like, to supply the hydraulic pressure into a pressure chamber, thereby to advance the master piston. According to this hydraulic brake apparatus, it is easy to produce the apparatus in such a manner that when the pressure in the wheel brake cylinder is reduced, the brake fluid is drained to a reservoir under atmospheric pressure provided for the master cylinder, whereby an inexpensive apparatus will be constituted. In this apparatus, however, the master piston is advanced, with the pressure reducing operation repeated. As a result, after the master piston reached the front end of the cylinder, the hydraulic braking pressure can not be supplied from the master cylinder to the wheel brake cylinder. In this case, therefore, it may be so constituted that the hydraulic pressure discharged from the pressure source (and regulated, if necessary) is supplied to a passage between the master cylinder and the pressure control valve. Presumably, the apparatus as disclosed in the U.S. patent has been proposed for a similar purpose, so that it can be understood that a valve was provided for opening or closing the passage for supplying the pressure to the master cylinder, or a switch was provided for monitoring the stroke of the master piston.

According to the hydraulic brake apparatus having such master cylinder that the master chamber is communicated with the reservoir under atmospheric pressure when the master piston is placed in its rearmost initial position, as can be understood from the disclosure of the U.S. patent, if the hydraulic pressure was added to the master chamber so that the hydraulic pressure in the master chamber is close to the hydraulic pressure in the pressure chamber for driving the master piston, to reduce the pressure difference between them, the master piston will be moved rearward by biasing force of a return spring. As a result, if the master piston is returned to its rearmost initial position so that the master chamber is communicated with the reservoir under atmospheric pressure, the hydraulic pressure in the master chamber will be reduced rapidly. In order to avoid this, therefore, it is presumed that the passage for supplying the pressure to the master cylinder was adapted to be blocked by the valve, or the position of the master piston was adapted to be monitored, which result in the expensive apparatus provided with the valve or switch.

### SUMMARY OF THE INVENTION

Accordingly, it is an object of the present invention to provide a hydraulic brake apparatus for a vehicle, which is capable of ensuring a braking operation by means of a master cylinder, and supplying hydraulic pressure appropriately to a hydraulic pressure braking system including the master cylinder, during a hydraulic pressure control in the wheel brake cylinder, with a simple and inexpensive structure.

In order to accomplish the above and other objects, the hydraulic brake apparatus is provided with a pressure source for generating hydraulic pressure, a pressure regulator valve for regulating the hydraulic pressure generated by the pressure source in response to an input state, a master cylinder having a master piston for defining a pressure chamber for receiving therein the hydraulic pressure fed from the pressure regulator valve, and a master chamber for discharging hydraulic braking pressure, wherein the master piston is advanced by the hydraulic pressure in the pressure chamber to discharge the hydraulic braking pressure from the master chamber. And, the hydraulic braking pressure discharged from the master chamber is set to be lower than the hydraulic pressure in the pressure chamber, to produce a pressure difference increased in response to advance of the master piston. The apparatus further includes a wheel brake cylinder operatively mounted on each wheel of the vehicle for applying braking force to the wheel with the hydraulic braking pressure fed from the master chamber, a pressure control valve disposed between the master chamber and the wheel brake cylinder for controlling the hydraulic braking pressure in the wheel brake cylinder, and a pressure supply device for supplying the hydraulic pressure in the pressure chamber reduced in pressure by a predetermined value, into the master chamber.

In the hydraulic brake apparatus as described above, the master cylinder preferably includes a return spring for biasing the master piston, with a load applied thereto for providing the hydraulic braking pressure discharged from the master chamber to be lower than the hydraulic pressure in the pressure chamber, to produce the pressure difference. With the master piston advanced forward, the load to the return spring is increased, so that the pressure difference is increased in response to advance of the master piston. In the vehicle stability control, for example, the hydraulic pressure in the pressure chamber is reduced by the pressure supply device by the amount of the predetermined value and supplied to the master chamber, whereby the hydraulic braking pressure discharged from the master chamber is made lower than the hydraulic pressure in the pressure chamber. Therefore, it can be so constituted that the master piston will not be returned to its initial position, even if the hydraulic pressure in the master chamber is increased by the hydraulic pressure in the pressure chamber, whereby the hydraulic pressure can be held in the master chamber. As for the input state as described above, it includes an operating state of a manually operated braking member by a vehicle driver, operating state of an automatic pressurizing device for directly actuating a pressure regulator valve, or the like.

In the hydraulic brake apparatus as described above, the pressure supply device may include a relief valve for communicating the pressure chamber with the master chamber when the hydraulic braking pressure in the master chamber is lower than the hydraulic pressure in the pressure chamber by a value equal to or greater than the predetermined value. The pressure supply device may further include a normally closed switching valve with one port thereof connected to the pressure chamber and the other one port connected to the relief valve.

In the hydraulic brake apparatus as described above, the pressure supply device may be adapted to reduce the hydraulic pressure in the pressure chamber to be supplied into the master chamber, up to the value reduced in pressure for allowing the master piston to return to a predetermined position in the master cylinder. Preferably, the predetermined position is set to be a position immediately before a rearmost initial position of the master piston returns.

The master cylinder as described above may be of a tandem type which includes a first master piston formed by the master piston, a second master piston disposed in the master cylinder in front of the first master piston, with a predetermined distance spaced between the first master piston and the second master piston to define a first master chamber therebetween, and define a second master chamber between the second master piston and a front end of the master cylinder, a first return spring disposed in the first master chamber and a second return spring disposed in the second master chamber. Preferably, a load for mounting the first return spring is set to be greater than a load for mounting the second return spring. And, the pressure supply device may be adapted to supply the hydraulic pressure in the pressure chamber reduced in pressure by a predetermined value, into the first master chamber and second master chamber.

As for the tandem master cylinder, the pressure supply device may comprise a first relief valve connected to the first master chamber, a second relief valve connected to the second master chamber, and a normally closed switching valve with one port thereof connected to the pressure chamber and the other one port connected to the first relief valve and second relief valve. Instead, the pressure supply device may comprise a first normally closed switching valve connected to the first master chamber, a second normally closed switching valve connected to the second master chamber, and a relief valve with one port thereof connected to the pressure chamber and the other one port thereof connected to the first normally closed switching valve and second normally closed switching valve.

Or, the hydraulic brake apparatus may be provided with a pressure source for generating hydraulic pressure, a reservoir for storing brake fluid under atmospheric pressure, a changeover device for controlling the communication between the reservoir and the pressure source, and a master cylinder having a master piston for defining a pressure chamber for receiving therein the hydraulic pressure fed from the pressure source and drained to the reservoir through the changeover device to be controlled thereby into a predetermined pressure, and a master chamber for discharging hydraulic braking pressure, wherein the master piston is advanced by the hydraulic pressure in the pressure chamber to discharge the hydraulic braking pressure from the master chamber. And, the hydraulic braking pressure discharged from the master chamber is set to be lower than the hydraulic pressure in the pressure chamber, to produce a pressure difference increased in response to advance of the master piston. The apparatus further includes the wheel brake cylinder, pressure control valve, and pressure supply device including the relief valve, as described above. In this apparatus, the changeover device may comprise a first linear proportioning solenoid valve connected to the reservoir and a second linear proportioning solenoid valve connected to the pressure source.

### BRIEF DESCRIPTION OF THE DRAWINGS

The above stated objects and following description will become readily apparent with reference to the accompanying drawings, wherein like reference numerals denote like elements, and in which:

FIG. 1 is a sectional view of a hydraulic brake apparatus according to an embodiment of the present invention;

FIG. 2 is a sectional view of a hydraulic brake apparatus according to another embodiment of the present invention; and

FIG. 3 is a sectional view of a part of a hydraulic brake apparatus provided with another embodiment of a pressure supply device according to the present invention.

### DESCRIPTION OF THE PREFERRED EMBODIMENTS

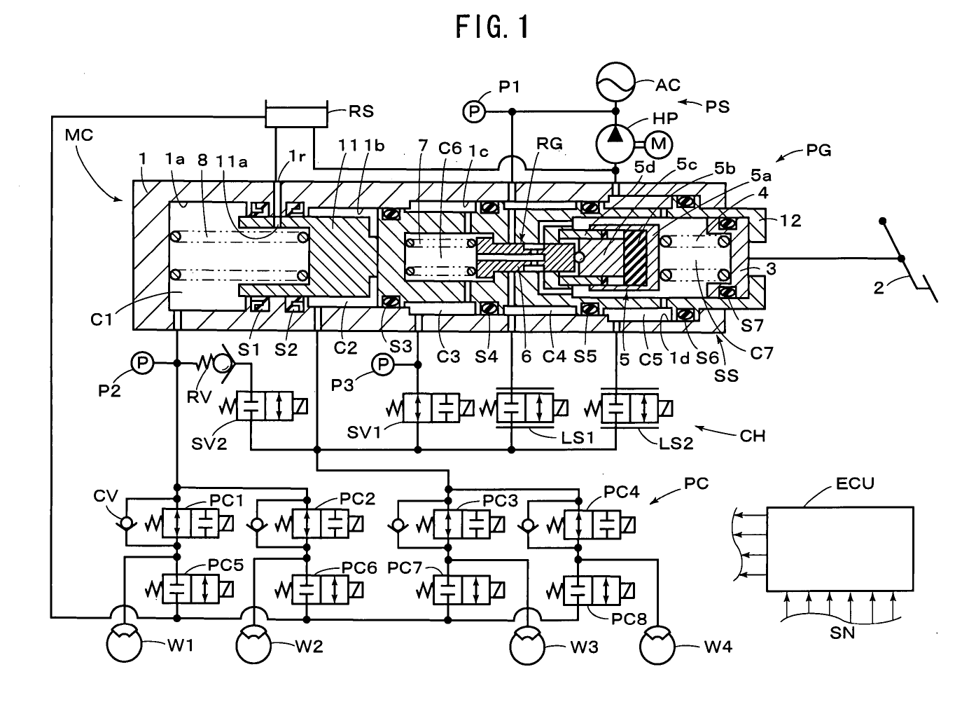

Referring to FIG. 1, there is illustrated a hydraulic brake apparatus for a vehicle according to an embodiment of the present invention, which includes a pressure generator PG for generating hydraulic pressure in response to operation of a brake pedal 2, which serves as the manually operated braking member. The apparatus includes wheel brake cylinders W1-W4, each of which is operatively mounted on each wheel of the vehicle, to apply braking force to the wheel with the hydraulic pressure fed from the pressure generator PG. Between the pressure generator PG and the wheel brake cylinders W1-W4, there are disposed a pressure control valve PC and changeover device CH.

According to the present embodiment, the pressure generator PG is provided with a pressure source PS for generating a certain hydraulic pressure irrespective of operation of the brake pedal 2. The pressure source PS includes an electric motor M controlled by an electronic control unit ECU, and a hydraulic pressure pump HP, which is driven by the electric motor M, and whose inlet is connected to a reservoir under atmospheric pressure RS (hereinafter, simply referred to as a reservoir RS), and whose outlet is connected to an accumulator AC. According to the present embodiment, a pressure sensor P1 is connected to the outlet, and the detected pressure is monitored by the electronic control unit ECU. On the basis of the monitored result, the motor M is controlled by the electronic control unit ECU to keep the hydraulic pressure in the accumulator AC between predetermined upper and lower limits.

In a cylinder 1 which serves as a body portion of the pressure generator PG, there is formed a stepped bore which includes bores 1a, 1b, 1c and 1d having different inner diameters from one another, and in which a master piston 11 and an auxiliary piston 12 are received. In the auxiliary piston 12, there are accommodated a regulator valve RG and a stroke simulator SS, which will be described later. Although the cylinder 1 is illustrated as one body in FIG. 1 to be understood easily, it is formed with a plurality of cylindrical members assembled together in practice. In the inner surface of the bore 1a of cylinder 1, there are disposed annular cup-like seal members S1 and S2, into which the master cylinder 11 in the shape of a cylinder with a bottom is fluid-tightly and slidably fitted. The auxiliary piston 12 has a plurality of land portions, which are formed around its outer surface, and on which a plurality of seal members S3-S6 are disposed, respectively. And, the auxiliary piston 12 is fitted into the bore 1b through the seal member S3, and in a bore 1c with a larger diameter than that of the bore 1b through the seal members S4 and S5, and in a bore 1d with a yet larger diameter than that of the bore 1c through the seal member S6, respectively. Thus, the auxiliary piston 12 is accommodated in the stepped cylinder bore as described above, and normally biased rearward because of the pressure relationship as explained later, to be held in its initial position as shown in FIG. 1. Then, if the pressure source PS is failed to discharge the hydraulic pressure, the auxiliary piston 12 is released from being held rearward, so that it comes to be in a state capable of being moved forward.

As shown in FIG. 1, a master chamber C1 is defined in the bore 1a of the cylinder 1 between the master piston 11 at the seal member S1 and the front end of the cylinder 1, and a pressure chamber C2 is defined in the bore 1b between the master piston 11 at the seal member S2 and the auxiliary piston 12 at the seal member S3. In FIG. 1, the front of the cylinder 1 is directed to the left. Thus, the master cylinder MC is formed in the front section of the cylinder 1. Furthermore, between the inner surfaces of the bores 1b, 1c and 1d of the cylinder 1 and the outer surface of the auxiliary piston 12, an annular chamber C3 is defined between the seal member S3 and the seal member S4, an annular chamber C4 is defined between the seal member S4 and the seal member S5, and an annular chamber C5 is defined between the seal member S5 and the seal member S6, respectively.

In the auxiliary piston 12, there is accommodated a spool valve mechanism which serves as the pressure regulator valve RG according to the present embodiment. In front of a spool 6, a regulator chamber C6 is defined to communicate with the annular chamber C3, and a low pressure chamber C7 is defined at the rear of the spool 6 to communicate with the annular chamber C5. An input piston 3 is fluid-tightly and slidably fitted into the auxiliary piston 12, so that the low pressure chamber C7 is defined in front of the input piston 3. Within the low pressure chamber C7, there are accommodated a distribution device 5 and a compression spring 4 for transmitting the braking operation force applied to the input piston 3 and providing a stroke for the input piston 3 in response to the braking operation force, to form the stroke simulator SS. Instead of the compression spring 4, any elastic member such as a rubber, air spring or the like may be employed.

The distribution device 5 is provided for adjusting the relationship between the braking operation force applied to the brake pedal 2 and the hydraulic pressure discharged from the pressure regulator valve RG. It includes a cylindrical member 5d with its front end abutting on the front end face of the auxiliary piston 12 in the low pressure chamber C7, and with its rear end mounting a plastic ring member thereon, a case 5a formed in the shape of a cylinder with a bottom, for slidably receiving therein the cylindrical member 5d, a rubber disc 5b disposed between the case 5a and the cylindrical member 5d, and a transmitting member 5c with a steel ball mounted on its front end. According to the distribution device 5, when the brake pedal 2 is depressed, the braking force is transmitted to the spool 6 through the input piston 3, compression spring 4, case 5a, rubber disc 5b and transmitting member 5c, so that the pressure regulator valve RG is operated to output the hydraulic pressure exerted in the regulator chamber C6, from the annular chamber C3. When the braking operation force exceeds a predetermined value, the elastically deformed rubber disc 5b abuts on the plastic ring member mounted on the cylindrical member 5d, so that a part of the braking operation force is distributed to be transmitted to the auxiliary piston 12 through the rubber disk 5b. According to the present embodiment, therefore, can be given a jumping property which provides a steep rise of pressure in the beginning of the braking operation. Also, with the inner diameter of the cylindrical member 5d and the outer diameter of the transmitting member 5c varied, a distribution ratio of the braking operation to be transmitted can be varied. Furthermore, with the length of the transmitting member 5c varied, a starting time for the distribution of the braking operation can be varied. Therefore, by combining the cylindrical member 5d and transmitting member 5c of different dimensions appropriately, the output property of the pressure regulator valve RG in response to the braking operation force can be provided as required. The distribution device 5 may be omitted, instead, it may be so constituted as to transmit the braking operation force directly to the spool 6.

As for the pressure regulator valve RG of the present embodiment, the compression spring 7 which acts as a return spring is accommodated in the regulator chamber C6 to press the spool 6 rearward by its biasing force. The load for mounting the compression spring 7 is set to be larger than the load for mounting the compression spring 4, so that when the brake pedal 2 is not depressed, the state as shown in FIG. 1 is maintained. The low pressure chamber C7 is connected to the reservoir RS together with the inlet of the pressure source PS, through the annular chamber C5, so that the annular chamber C5 and low pressure chamber C7 are filled with the brake fluid under approximately atmospheric pressure in the reservoir RS. The annular chamber C4 is connected to the accumulator AC of the pressure source PS, so that the hydraulic pressure discharged from the pressure source PS is supplied, to provide a relatively high pressure chamber.

Accordingly, when the spool 6 is placed at the rearmost initial position as shown in FIG. 1, the regulator chamber C6 is communicated with the low pressure chamber C7 through the spool 6 to be under the atmospheric pressure as in the reservoir RS. When the input piston 3 is moved forward, and then the spool 6 is moved forward to block the communication between the regulator chamber C6 and the low pressure chamber C7, the pressure in the regulator chamber C6 will be held. When the spool 6 is moved forward further, the regulator chamber C6 is communicated with the pressure source PS through the spool 6, auxiliary piston 12 and annular chamber C4, so that the hydraulic pressure discharged from the pressure source PS is fed into the regulator chamber C6 to increase the hydraulic pressure therein, thereby to provide a pressure increasing state. Thus, in accordance with a repetition of relative movement of the spool 6 to the auxiliary piston 12, the hydraulic pressure in the regulator chamber C6 is regulated into a predetermined pressure, and discharged from the annular chamber C3 to the pressure chamber C2 through a switching solenoid valve (hereinafter, simply referred to as switching valve) SV1 placed in its open position, and also discharged to the wheel brake cylinders W3 and W4 thorough switching solenoid valves (hereinafter, simply referred to as switching valves) PC3 and PC4, as will be described later.

In the master chamber C1, there is accommodated a compression spring 8 which acts as a return spring, and which forces the rear end surface of the master piston 11 to abut on the front end surface of the auxiliary piston 12. In other words, when the master piston 11 is placed at its rearmost initial position, a communication hole 11a defined on a skirt portion of the master piston 11 is communicated with a communication hole 1r defined on a cylinder 1, so that the master chamber C1 is under approximately atmospheric pressure as in the reservoir RS. When the master piston 11 is moved forward, the communication hole 1r will be closed by its skirt portion, to block its communication with the reservoir RS. Therefore, when the master piston 11 in this state is further moved forward, the hydraulic pressure in the master chamber C1 will be increased.

As shown in FIG. 1, according to the present embodiment, the wheel brake cylinders W1 and W2 operatively mounted on the front wheels are connected to the master chamber C1 through the switching valves PC1 and PC2, respectively. On the contrary, the wheel brake cylinders W3 and W4 operatively mounted on the rear wheels are connected to the pressure chamber C2 through the switching valves PC3 and PC4, respectively, and also connected to the annular chamber C3 (then to the regulator chamber C6) through the switching valve SV1. Consequently, the hydraulic pressure output from the regulator chamber C6 is supplied to the wheel brake cylinders W3 and W4 through the switching valve SV1 and the switching valves PC3 and PC4 placed in their open positions. Also, the hydraulic pressure output from the regulator chamber C6 is supplied from the annular chamber C3 to the pressure chamber C2 through the switching valve SV1 placed in its open position, to advance the master piston 11, so that the hydraulic pressure output from the master chamber C1 is supplied to the wheel brake cylinders W1 and W2 through the switching valves PC1 and PC2 placed in their open positions.

According to the present embodiment, a pressure sensor P2 is disposed in a hydraulic passage of the master chamber C1 at the output side thereof, and a pressure sensor P3 is disposed in a hydraulic passage of the annular chamber C3 (regulator chamber C6) at the output side thereof, and signals detected by the sensors P2 and P3 are fed to the electronic control unit ECU. Thus, the hydraulic pressure output from the pressure generator PG is monitored and provided for the automatic braking control in case of performing the vehicle stability control, or controlling the distance between vehicles, as will be described later. Furthermore, In order to achieve those controls, sensors (indicated by “SN” in FIG. 1) such as wheel speed sensors, acceleration sensor or the like have been provided, so that the signals detected by them are fed to the electronic control unit ECU.

Furthermore, according to the present embodiment, the switching valves PC1-PC8, switching valves SV1 and SV2, and linear proportioning solenoid valves LS1 and LS2 are controlled by the electronic control unit ECU, to perform various controls including the vehicle stability control. As shown in FIG. 1, the switching valves PC1 and PC5, and the switching valves PC2 and PC6, for use in the control of supplying and draining the hydraulic pressure respectively, are disposed in hydraulic circuits connecting the master chamber C1 and the wheel brake cylinders W1 and W2 operatively mounted on the front wheels, respectively. Also, the switching valves PC3 and PC7, and the switching valves PC4 and PC8, for use in the control of supplying and draining the hydraulic pressure respectively, are disposed in hydraulic circuits connecting the pressure chamber C2 and the wheel brake cylinders W3 and W4 operatively mounted on the rear wheels, respectively. The switching valves PC1-PC4 for supplying the hydraulic pressure are normally opened, while the switching valves PC5-PC8 for draining the hydraulic pressure are normally closed, and connected to the reservoir RS, respectively. In parallel with the switching valves PC1-PC4, a check valve CV is disposed, respectively, so that when the brake pedal BP is released, the flow of brake fluid in the wheel brake cylinders W1-W4 to the master chamber C1 and pressure chamber C2 is allowed, respectively, whereas its reverse flow is blocked. In FIG. 1, the hydraulic system has been divided into a pressure control circuit for the front wheels and a pressure control circuit for the rear wheels to provide a front-rear circuit system. Instead, a so-called diagonal circuit system may be employed. The switching valves PC1 and PC5 may be assembled together with each check valve CV, to provide a changeover valve for use in the control of supplying and draining the hydraulic pressure.

The changeover device CH includes the switching valves SV1 and SV2, and the linear proportioning solenoid valves LS1 and LS2, which are appropriately switched to perform an automatic braking control for the vehicle stability control or the like. The switching valve SV1 is disposed in a hydraulic passage for connecting the pressure chamber C2 (and the switching valves PC3 and PC4) with the annular chamber C3 (and the regulator chamber C6). The switching valve SV1 is a normally open two-port two-position solenoid operated switching valve, so that it is placed in its open position as shown in FIG. 1 when de-energized, to communicate the pressure chamber C2 (and the switching valves PC3 and PC4) with the annular chamber C3 (and the regulator chamber C6), whereas it is placed in its closed position when energized, to block the communication between them. Also, the linear proportioning solenoid valve LS1 is disposed in a hydraulic passage for connecting the pressure chamber C2 (and the switching valves PC3 and PC4) with the annular chamber C4 (and finally with the pressure source PS), and the linear proportioning solenoid valve LS2 is disposed in a hydraulic passage for connecting the pressure chamber C2 (and the switching valves PC3 and PC4) with the annular chamber C5 (and finally with the reservoir RS). Both of the linear proportioning solenoid valves LS1 and LS2 are placed in their closed positions as shown in FIG. 1 when de-energized, and they are placed in their open positions when energized, to control each pressure difference between the fore and behind them, respectively, to be of a value provided in response to the electric current for exciting each solenoid.

Furthermore, the pressure chamber C2 (and the switching valves PC3 and PC4, switching valve SV1, and linear proportioning solenoid valve LS1 and LS2, as well) is connected to a hydraulic passage between the master chamber C1 and the switching valves PC1 and PC2, through the switching valve SV2 and a relief valve RV. The switching valve SV2 is a normally closed two-port two-position solenoid operated switching valve, so that it is placed in its closed position as shown in FIG. 1 when de-energized, to block the communication, whereas it is opened when energized, to communicate the pressure chamber C2 with master chamber C1 (and the switching valves PC1 and PC2) through the relief valve RV.

The switching valve SV2 constitutes the pressure supply device according to the present invention, together with the relief valve RV and the electronic control unit ECU for controlling the switching valve SV2. If the pressure increasing and decreasing in the wheel brake cylinders W1 and W2 are repeated frequently during the vehicle stability control for example, the amount of brake fluid returned from the master chamber C1 to the reservoir RS is increased, so that the amount of brake fluid in the master chamber C1 is reduced relatively. In order to compensate the reduced amount, the pressure supply device including the switching valve SV2 has been disposed as described above, and as shown in FIG. 1. For example, in the case where it is estimated that the amount of brake fluid in the master chamber C1 has been reduced to be equal to or smaller than a predetermined amount, the switching valve SV2 is placed in its open position, so that the brake fluid can be supplied from the pressure chamber C2 (and the pressure source PS). Whether the amount of brake fluid in the master chamber C1 has been reduced to be equal to or smaller than the predetermined amount can be determined by monitoring the time for exciting the switching valves PC5 and PC6 to be placed in their open positions, for example. According to the present embodiment, however, such determination is not required, because the relief valve RV has been disposed, as will be explained in detail hereinafter.

As shown in FIG. 1, the relief valve RV has been disposed in series of the switching valve SV2, according to the present embodiment. The relief valve RV is provided for reducing the hydraulic pressure in the master chamber C1 to be lower than the hydraulic pressure in the pressure chamber C2 by a predetermined value, in order that the master piston 11 will not be returned to its rearmost initial position, when the total of a biasing force of the compression spring 8 and the force produced by the hydraulic pressure in the master chamber C1 has come to be greater than the force produced by the hydraulic pressure in the pressure chamber C2. In other words, the relief valve RV is adapted to be opened, when the hydraulic pressure in the hydraulic passage between the master chamber C1 and the switching valves PC1 and PC2 is lower than the hydraulic pressure in the pressure chamber C2 by a value equal to or greater than the predetermined value. In the case where the pressure for opening the relief valve RV is set, or the case where another embodiment is provided for the pressure supply device, in view of the amount of reduced pressure in the master chamber C1, it may be so constituted that the hydraulic pressure in the pressure chamber C2 (i.e., the hydraulic pressure discharged from the pressure source PS or pressure regulator valve RG) to be supplied into the master chamber C1, is limited to be reduced, up to the value reduced in pressure for allowing the master piston 11 to return to a predetermined position (e.g., a position immediately before a rearmost initial position of the master piston 11).

In operation, according to the pressure generator PG of the hydraulic brake apparatus of the embodiment as shown in FIG. 1, when the brake pedal 2 is not depressed, the input piston 3 and the spool 6 of the pressure regulator valve RG are in the state as shown in FIG. 1. In this state, the spool 6 has been pressed onto the auxiliary piston 12 by the biasing force of the compression spring 7, so that the communication between the regulator chamber C6 and the annular chamber C4 is blocked, whereas the regulator chamber C6 is communicated with the low pressure chamber C7 (i.e., the pressure decreasing state). Consequently, the regulator chamber C6 has been communicated with the reservoir RS to be under approximately atmospheric pressure, the hydraulic pressure output from the regulator chamber C6 is not supplied to the pressure chamber C2, so that the master piston 11 is held in its initial position as shown in FIG. 1.

When depressing force is applied to the brake pedal 2, the braking operation force is transmitted to the spool 6 through the input piston 3, compression spring 4 and distribution device 5, to advance the spool 6, with the compression spring 7 being compressed. In this occasion, the compression spring 4 is compressed to function as a stroke simulator. When the brake pedal 2 is depressed further against the biasing force of the compression spring 7, and the spool 6 is placed at a position where the regulator chamber C6 does not communicate with the annular chamber C4, nor the low pressure chamber C7, the pressure holding state is provided. When further depressing force is applied to the brake pedal 2 to advance the spool 6, the regulator chamber C6 will communicate with the annular chamber C4, with the communication between the regulator chamber C6 and the low pressure chamber C7 being blocked, so that the regulator chamber C6 will communicate with the annular chamber C4, to supply the hydraulic pressure output from the pressure source PS to the regulator chamber C6 through the annular chamber C4. As a result, the pressure increasing state is provided.

Therefore, if the brake pedal 2 is operated in the pressure decreasing state as shown in FIG. 1, the hydraulic pressure in the regulator chamber C6 is regulated by the pressure regulator valve RG into the hydraulic pressure determined in response to the force transmitted from the input piston 3 to the spool 6 through the compression spring 4 and distribution device 5, then the regulated pressure is supplied to the pressure chamber C2, and supplied to the wheel brake cylinders W3 and W4 through the switching valves PC3 and PC4 placed in their open positions, and at the same time the master piston 11 is actuated by the regulated pressure. Consequently, the hydraulic pressure determined in response to the braking operation force is supplied from the master chamber C1 to the wheel brake cylinders W3 and W4, and the compression spring 4 of the stroke simulator SS is compressed, to provide a stroke determined in response to the braking operation force, and given to the input piston 3 and finally to the brake pedal 2.

Then, according to the present embodiment, the switching valves PC1-PC8, switching valves SV1 and SV2, and linear proportioning solenoid valves LS1 and LS2 are controlled by the electronic control unit ECU, to perform various controls including the vehicle stability control as follows. In the vehicle stability control which is performed without the brake pedal 2 being operated, the hydraulic pressure is not discharged from the pressure regulator valve RG, nor discharged from the master chambers C1 and C2. In this case, therefore, the switching valve SV1 is closed, the switching valve SV2 is opened, and then the linear proportioning solenoid valves LS1 and LS2 are controlled. As a result, the hydraulic pressure discharged from the pressure source PS can be supplied (from the annular chamber C4) into the wheel brake cylinders W3 and W4, through the linear proportioning solenoid valve LS1 placed in its open position, and switching valves PC3 and PC4 placed in their open positions. Also, the hydraulic pressure discharged from the pressure source PS is supplied into the pressure chamber C2 thereby to advance the master piston 11, so that the hydraulic pressure discharged from the master chamber C1 can be supplied into the wheel brake cylinders W1 and W2, through the switching valves PC1 and PC2 placed in their open positions. Furthermore, if the switching valve SV2 is placed in its open position, the hydraulic pressure in the pressure chamber C2 (in this case, the hydraulic pressure discharged from the pressure source PS) can be supplied into the master chamber C1, through the relief valve RV.

Accordingly, in response to the signals detected by each sensor SN, the electronic control unit ECU is operated to control the linear proportioning solenoid valves LS1 and LS2, and open or close the switching valves PC1-PC8, thereby to control the hydraulic braking pressure in each wheel brake cylinder to be rapidly increased, gradually increased (pulse increase mode), gradually decreased (pulse decrease mode), rapidly decreased, or held, so that the hydraulic pressure control required for the vehicle stability control can be made. In this hydraulic pressure control, if the hydraulic pressure in the passage between the master chamber C1 and the switching valves PC1 and PC2 is lower than the hydraulic pressure in the pressure chamber by a value equal to or greater than the predetermined value, the relief valve RV is opened, so that the hydraulic pressure in the pressure chamber C2 (the pressure source PS) will be supplied into the master chamber C1 through the switching valve SV2 placed in its open position and the relief valve RV, with the brake fluid added into the master chamber C1. As a result, the hydraulic pressure in the master chamber C1 is increased, and with the total of the force by the pressure and the biasing force of the compression spring 8 increased to be greater than the force by the pressure in the pressure chamber C2, the master piston 11 will be moved rearward and balanced at a position immediately before the hole 11a of the master piston 11 is communicated with the hole 1r of the cylinder 1, so that the master piston 11 will not be moved rearward beyond that position. Therefore, the brake fluid in the master chamber C1 will be held, without being drained to the reservoir RS. When the pressure generator PG is stopped, and the hydraulic pressure in the pressure chamber C2 is lost, the master piston 11 will be returned by the biasing force of the compression spring 8 to the position where the hole 11a is communicated with the hole 1r of the cylinder 1, so that the brake fluid in the master chamber C1 will be returned to the reservoir RS.

In the vehicle stability control as described above, the pressure generator PG is actuated irrespective of operation of the brake pedal 2, the hydraulic pressure supplied by the pressure source PS through the annular chamber C4 is used. In the anti-skid control or the like which is to be performed when the brake pedal 2 is depressed, the hydraulic pressure discharged from the pressure regulator valve RG is used. In the latter case, therefore, the switching valve SV1 is placed in its open position, so that the hydraulic pressure discharged from the regulator chamber C6 is supplied into the pressure chamber C2. In this case, the auxiliary piston 12 is held at the position as shown in FIG. 1, with the hydraulic pressure in the pressure chamber C2 and the hydraulic pressure in the annular chamber C3 applied to it. Then, if the pressure source PS is failed during the operation of the pressure generator PG, the hydraulic pressure is not discharged from the pressure source PS to the annular chamber C4. In this case, therefore, when the input piston 3 is advanced in response to operation of the brake pedal 2, the spool 6 is advanced against the biasing force of the compression spring 7, and the input piston 3 is advanced against the biasing force of the compression spring 4, so that the force applied to the brake pedal 2 is transmitted to the auxiliary piston 12 through the distribution device 5, and further transmitted to the master piston 11, whereby the hydraulic braking pressure is supplied from the master chamber C1 to the wheel brake cylinders W1 and W2.

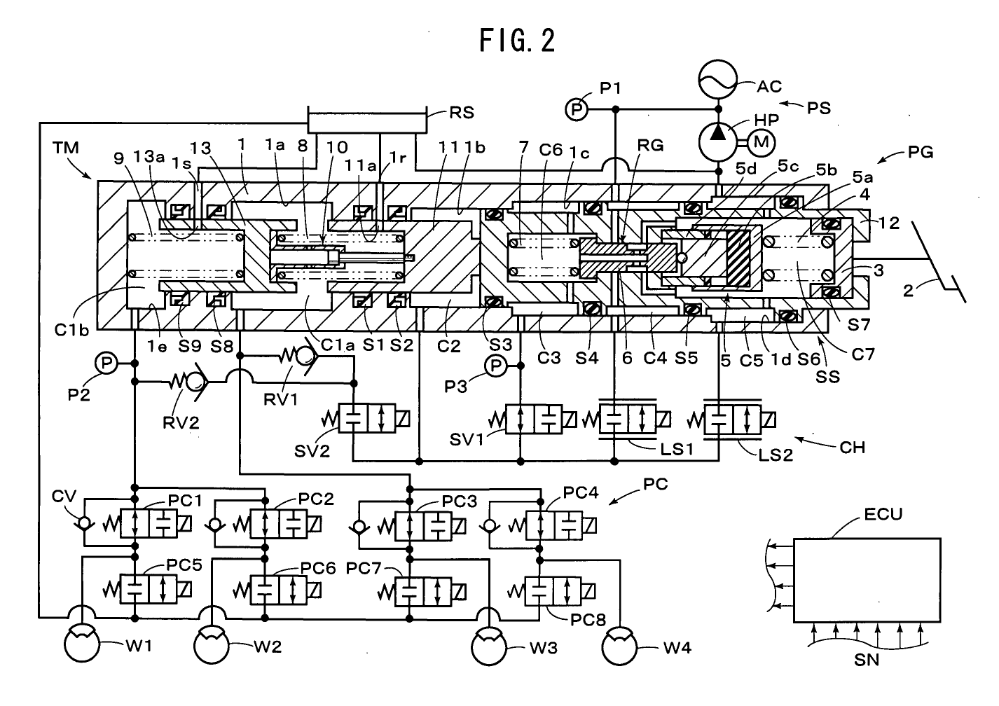

Next will be explained another embodiment of the present invention, with reference to FIG. 2, wherein in addition to the structure as shown in FIG. 1, another master piston 13 has been disposed as a second master piston in front of the master piston 11 as a first master piston, to provide a tandem master cylinder TM. That is, a first master chamber C1a is defined in the bore 1a of the cylinder 1 between the master piston 11 at the seal member S1 and the master piston 13 at the seal member S8, and a second master chamber C1b is defined in the bore 1e formed in front of the bore 1a, between the master piston 13 at the seal member S9 and the front inner end wall of the cylinder 1, whereby the tandem master cylinder TM is formed in the front section of the cylinder 1. In the first master chamber C1a, a retainer 10 is disposed to mount thereon a compression spring 8 which serves as a first return spring. Therefore, a so-called suspension structure is constituted, whereby the space between the master piston 11 and the master piston 13 is limited to a predetermined distance by the retainer 10. In the second master chamber C1b, there is disposed a compression spring 9 which serves as a second return spring. The load for mounting the compression spring 8 (first return spring) has been set to be larger than the load for mounting the compression spring 9 (second return spring).

Accordingly, the master piston 13 (and 11) is forced rearward by the biasing force of the compression spring 9 to be held at the rearmost initial position as shown in FIG. 2, and the first master chamber C1a and second master chamber C1b are communicated with the reservoir RS. When the master piston 13 is placed at its rearmost initial position, a communication hole 13a defined on its skirt portion is communicated with a communication hole is defined in the cylinder 1 is communicated with the reservoir RS, to be under approximately atmospheric pressure as in the reservoir RS. When the master piston 13 is moved forward, the hole is will be closed by its skirt portion, to block its communication with the reservoir RS. Therefore, when the master piston 13 is further moved forward, the hydraulic pressure in the master chamber C1a will be increased.

According to the present embodiment, the first master chamber C1a is connected to the wheel brake cylinders W3 and W4 through the switching valves PC3 and PC4, respectively, and the second master chamber C1b is connected to the wheel brake cylinders W1 and W2 through the switching valves PC1 and PC2, respectively. The pressure chamber C2 is connected to a passage between the first master chamber C1a and the switching valves PC3 and PC4 through the switching valve SV2 and relief valve RV1, and also connected to a passage between the second master chamber C1b and the switching valves PC1 and PC2 through the switching valve SV2 and relief valve RV2. The relief valve RV2 is the same as the relief valve RV1. In other words, as the load for mounting the compression spring 8 has been set to be greater than the load for mounting the compression spring 9, the relief valves RV1 and RV2 can be formed to be identical. As the remaining structure is substantially the same as the structure as shown in FIG. 1, its explanation is omitted herein, with the same reference numerals given to substantially the same elements as shown in FIG. 1.

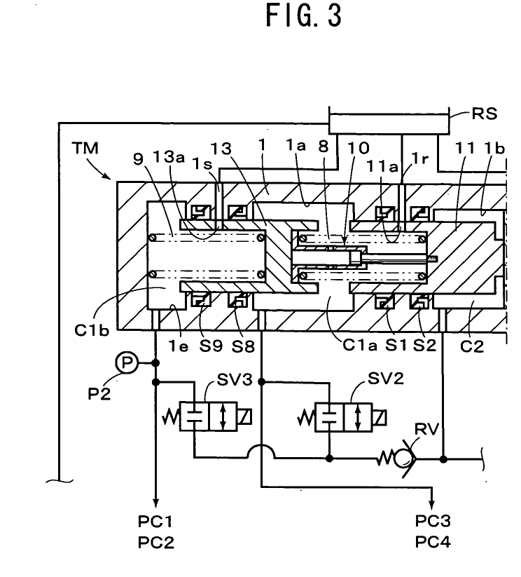

As described above, the pressure for opening the relief valves RV1 and RV2 has been provided so that the hydraulic pressure in the master chambers C1a and C1b is lower than the pressure chamber C2 by the predetermined value, respectively, according to the embodiment as shown in FIG. 2. Therefore, the master pistons 11 and 13 are returned to a position immediately before the holes 11a and 13a defined on their skirt portions are communicated with the holes 1r and 1s, respectively, but never returned directly to their rearmost initial positions. Consequently, the brake fluid in the master chambers C1a and C1b will not be drained to the reservoir RS. Particularly, according to the present embodiment, it is easy to manufacture and assemble the apparatus, because an adjustment is to be made only for the master piston 13 and the compression spring 9 (second return spring), without requiring any specific adjustment to the master piston 11. Furthermore, as shown in FIG. 3, a single relief valve (RV) and two switching valves SV2 and SV3 may be arranged to constitute the pressure supply device according to the present invention. As the remaining structure in FIG. 3 is the same as that in FIG. 2, its explanation is omitted herein.

Furthermore, the pressure regulator valve RG may be omitted in FIGS. 1 and 2, so that the linear proportioning solenoid valves LS1 and LS2 may be connected to the pressure source PS and reservoir RS, respectively. In this case, therefore, the linear proportioning solenoid valves LS1 and LS2 constitute the changeover means according to the present invention. In other words, the communication between the pressure source PS and the reservoir RS is made or blocked by the linear proportioning solenoid valves LS1 and LS2, whereby the hydraulic pressure in the pressure chamber C2 can be controlled to be a predetermined pressure. According to the structure as described above, with the remaining structure constituted as shown in FIGS. 1 and 2, it can achieve the effects similar to those achieved by the embodiments as shown in FIGS. 1 and 2.

It should be apparent to one skilled in the art that the above-described embodiments are merely illustrative of but a few of the many possible specific embodiments of the present invention. Numerous and various other arrangements can be readily devised by those skilled in the art without departing from the spirit and scope of the invention as defined in the following claims.

What is claimed is:

1. A hydraulic brake apparatus for a vehicle comprising:
a pressure source for generating hydraulic pressure;
a pressure regulator valve for regulating the hydraulic pressure generated by said pressure source in response to an input state;
a master cylinder having a master piston for defining a pressure chamber for receiving therein the hydraulic pressure fed from said pressure regulator valve, and a master chamber for discharging hydraulic braking pressure, said master piston being advanced by the hydraulic pressure in said pressure chamber to discharge the hydraulic braking pressure from said master chamber, wherein the hydraulic braking pressure discharged from said master chamber is set to be lower than the hydraulic pressure in said pressure chamber, to produce a pressure difference increased in response to advance of said master piston;
a wheel brake cylinder operatively mounted on each wheel of said vehicle for applying braking force to said wheel with the hydraulic braking pressure fed from said master chamber;
pressure control means disposed between said master chamber and said wheel brake cylinder for controlling the hydraulic braking pressure in said wheel brake cylinder; and
pressure supply means for supplying the hydraulic pressure in said pressure chamber reduced in pressure by a predetermined value, into said master chamber.

2. A hydraulic brake apparatus as set forth in claim 1, wherein said master cylinder includes a return spring for biasing said master piston, with a load applied thereto for providing the hydraulic braking pressure discharged from said master chamber to be lower than the hydraulic pressure in said pressure chamber, to produce the pressure difference increased in response to advance of said master piston.

3. A hydraulic brake apparatus as set forth in claim 1, wherein said pressure supply means includes a relief valve for communicating said pressure chamber with said master chamber when the hydraulic braking pressure in said master chamber is lower than the hydraulic pressure in said pressure chamber by a value equal to or greater than the predetermined value.

4. A hydraulic brake apparatus as set forth in claim 3, wherein said pressure supply means further includes a normally closed switching valve with one port thereof connected to said pressure chamber and the other one port connected to said relief valve.

5. A hydraulic brake apparatus as set forth in claim 1, wherein said pressure supply means reduces the hydraulic pressure in said pressure chamber to be supplied into said master chamber, up to the value reduced in pressure for allowing said master piston to return to a predetermined position in said master cylinder.

6. A hydraulic brake apparatus as set forth in claim 5, wherein said predetermined position is set to be a position immediately before a rearmost initial position of said master piston returns.

7. A hydraulic brake apparatus as set forth in claim 1, wherein said pressure control means communicates said wheel brake cylinder with a reservoir for storing brake fluid under atmospheric pressure, when the hydraulic braking pressure in said wheel brake cylinder is to be reduced.

8. A hydraulic brake apparatus as set forth in claim 1, wherein said master cylinder includes:
a first master piston formed by said master piston;
a second master piston disposed in said master cylinder in front of said first master piston, with a predetermined distance spaced between said first master piston and said second master piston to define a first master chamber therebetween, and define a second master chamber between said second master piston and a front end of said master cylinder;
a first return spring disposed in said first master chamber; and
a second return spring disposed in said second master chamber,
wherein a load for mounting said first return spring being set to be greater than a load for mounting said second return spring, and
wherein said pressure supply means supplies the hydraulic pressure in said pressure chamber reduced in pressure by a predetermined value, into said first master chamber and second master chamber.

9. A hydraulic brake apparatus as set forth in claim 8, wherein said pressure control means communicates said wheel brake cylinder with a reservoir for storing brake fluid under atmospheric pressure, when the hydraulic braking pressure in said wheel brake cylinder is to be reduced.

10. A hydraulic brake apparatus as set forth in claim 8, wherein said pressure supply means comprises a first relief valve connected to said first master chamber, a second relief valve connected to said second master chamber, and a normally closed switching valve with one port thereof connected to said pressure chamber and the other one port connected to said first relief valve and second relief valve.

11. A hydraulic brake apparatus as set forth in claim 8, wherein said pressure supply means comprises a first normally closed switching valve connected to said first master chamber, a second normally closed switching valve connected to said second master chamber, and a relief valve with one port thereof connected to said pressure chamber and the other one port thereof connected to said first normally closed switching valve and second normally closed switching valve.

12. A hydraulic brake apparatus for a vehicle comprising:
a pressure source for generating hydraulic pressure;
a reservoir for storing brake fluid under atmospheric pressure;
changeover means for controlling the communication between said reservoir and said pressure source;
a master cylinder having a master piston for defining a pressure chamber for receiving therein the hydraulic pressure fed from said pressure source and drained to said reservoir through said changeover means to be controlled thereby into a predetermined pressure, and a master chamber for discharging hydraulic braking pressure, said master piston being advanced by the hydraulic pressure in said pressure chamber to discharge the hydraulic braking pressure from said master chamber, wherein the hydraulic braking pressure discharged from said master chamber is set to be lower than the hydraulic pressure in said pressure chamber, to produce a pressure difference increased in response to advance of said master piston;
a wheel brake cylinder operatively mounted on each wheel of said vehicle for applying braking force to said wheel with the hydraulic braking pressure fed from said master chamber;
pressure control means disposed between said master chamber and said wheel brake cylinder for controlling the hydraulic braking pressure in said wheel brake cylinder; and
pressure supply means for supplying the hydraulic pressure in said pressure chamber reduced in pressure by a predetermined value, into said master chamber.

13. A hydraulic brake apparatus as set forth in claim 12, wherein said master cylinder includes a return spring for biasing said master piston, with a load applied thereto for providing the hydraulic braking pressure discharged from said master chamber to be lower than the hydraulic pressure in said pressure chamber, to produce the pressure difference increased in response to advance of said master piston.

14. A hydraulic brake apparatus as set forth in claim 12, wherein said pressure supply means includes a relief valve for communicating said pressure chamber with said master chamber when the hydraulic braking pressure in said master chamber is lower than the hydraulic pressure in said pressure chamber by a value equal to or greater than the predetermined value.

15. A hydraulic brake apparatus as set forth in claim 14, wherein said pressure supply means further includes a normally closed switching valve with one port thereof connected to said pressure chamber and the other one port connected to said relief valve.

16. A hydraulic brake apparatus as set forth in claim 12, wherein said pressure supply means reduces the hydraulic pressure in said pressure chamber to be supplied into said master chamber, up to the value reduced in pressure for allowing said master piston to return to a predetermined position in said master cylinder.

17. A hydraulic brake apparatus as set forth in claim 16, wherein said predetermined position is set to be a position immediately before a rearmost initial position of said master piston returns.

18. A hydraulic brake apparatus as set forth in claim 12, wherein said pressure control means communicates said wheel brake cylinder with said reservoir, when the hydraulic braking pressure in said wheel brake cylinder is to be reduced.

19. A hydraulic brake apparatus as set forth in claim 12, wherein said master cylinder includes:
a first master piston formed by said master piston;
a second master piston disposed in said master cylinder in front of said first master piston, with a predetermined distance spaced between said first master piston and said second master piston to define a first master chamber therebetween, and define a second master chamber between said second master piston and a front end of said master cylinder;
a first return spring disposed in said first master chamber; and
a second return spring disposed in said second master chamber,
wherein a load for mounting said first return spring being set to be greater than a load for mounting said second return spring, and
wherein said pressure supply means supplies the hydraulic pressure in said pressure chamber reduced in pressure by a predetermined value, into said first master chamber and second master chamber.

20. A hydraulic brake apparatus as set forth in claim 19, wherein said pressure control means communicates said wheel brake cylinder with said reservoir, when the hydraulic braking pressure in said wheel brake cylinder is to be reduced.

21. A hydraulic brake apparatus as set forth in claim 12, wherein said changeover means comprises a first linear proportioning solenoid valve connected to said reservoir and a second linear proportioning solenoid valve connected to said pressure source.
